(19) United States
(12) Patent Application Publication
(10) Pub. No.: US 2010/0289426 A1
(43) Pub. Date: Nov. 18, 2010

(54) ILLUMINATION DEVICE

(75) Inventors: Keitaro TAKASAKA, Yokosuka-Shi (JP); Koji Migita, Yokosuka-Shi (JP)

Correspondence Address: DLA PIPER LLP US, P. O. BOX 2758, RESTON, VA, 20195, US

(73) Assignees: TOSHIBA LIGHTING & TECHNOLOGY CORPORATION, Yokosuka-Shi (JP); KABUSHIKI KAISHA TOSHIBA, Minato-Ku (JP)

(21) Appl. No.: 12/777,303

(22) Filed: May 11, 2010

(30) Foreign Application Priority Data
May 12, 2009 (JP) 2009-115892

(51) Int. Cl. H05B 37/02

(52) U.S. Cl. 315/250

(57) ABSTRACT

The light source portion is provided with a plurality of LED circuits having a plurality of LEDs. A plurality of drive circuits are provided which cause the LEDs to be lit per LED circuit in response to input of PWM signals. The PWM control circuit outputs PWM signals per drive circuit in response to input of lighting control signals and simultaneously make the output timings of the PWM signals different from each other per drive circuit. By making the output timings of the PWM signals different, the period of time during which the LEDs are turned off can be reduced as the entirety of the light source portion, and the occurrence of flickering is reduced without increasing the lighting frequency.

### INCORPORATION BY REFERENCE

The present invention claims priority under 35 U.S.C. §119 to Japanese Patent Application No. 2009-115892 filed on May 12, 2009. The contents of these applications are incorporated herein by reference in their entirety.

### FIELD OF THE INVENTION

The present invention relates to an illumination device using LEDs as a light source.

### BACKGROUND OF THE INVENTION

As an illumination device which is used in a television studio and a theater, an illumination device which controls lighting by using LEDs as its light source has been developed.

In LED lighting control, there have been used a current control system which varies a current value with an electric current flown to LEDs at all times as described in, for example, Japanese Laid-Open Patent Publication No. 2008-210537, and a PWM (Pulse Width Modulation) control system which varies the period of time during which an electric current is flown to LEDs with the current value constant.

In the PWM control system, while the PWM control system has such a feature that no color temperature of the LEDs changes in lighting control, a problem occurs that flickering by which the brightness of picked-up pictures changes is brought about due to a difference between the vertical frequency of a television camera and the lighting frequency of the LEDs when being picked up by a television camera, in particular, when the lighting control ratio is low.

In order to prevent flickering from occurring, a change in the brightness of the LEDs is reduced with respect to the television camera by increasing the lighting frequency for the PWM control.

However, although flickering has conventionally been prevented from occurring by increasing the lighting frequency for PWM control, there is a problem that the component configuration becomes expensive because, in order to increase the lighting frequency for the PWM control, it is necessary to increase the capacity of the CPU of the control circuit and to improve the response efficiency of a drive circuit to drive the LEDs. Also, since the lighting cycle is shortened by increasing the lighting frequency for the PWM control, there is another problem that it becomes difficult to enlarge the number of gradations for the PWM control and it becomes impossible to smoothly control lighting of the LEDs.

The present invention was developed in view of such points, and it is therefore an object of the invention to provide an illumination device of which the component configuration can be made inexpensive by reducing the occurrence of flickering without increasing the lighting frequency.

### SUMMARY OF THE INVENTION

An illumination, device according to the claim 1 of the invention includes a light source portion including a plurality of LED circuits having LEDs; a plurality of drive circuits for causing the LEDs to be lit per LED circuit in response to input of a PWM signal; and a PWM control circuit for outputting a PWM signal per drive circuit in response to a lighting control signal and simultaneously making the output timings of the PWM signals different from each other per drive circuit.

Thus, since, by making the output timings of the PWM signals output from the PWM control circuit different from each other per drive circuit, the period of time during which the LEDs are turned off can be reduced as the entirety of the light source portion even if the lighting control ratio is lowered, a change in the brightness is reduced, and it is possible to reduce the occurrence of flickering without increasing the lighting frequency. Therefore, since it is not necessary to increase the lighting frequency to reduce flickering, the component configuration can be made inexpensive by lowering the lighting frequency. In addition, since the lighting frequency is not high, the LEDs can be smoothly controlled for lighting by enlarging the number of gradations.

The light source portion is, for example, an assembly of LEDs connected to a plurality of LED circuits, and is composed to be arrayed, for example, like a curvature or a plane. The LED circuit may be composed of at least two or more systems, and the number of LEDs incorporated in the LED circuit may be single or a plurality of two or more. Respective LEDs may be used which emit, for example, respective lights in red, green and blue in addition to LEDs which emit white light.

The drive circuit varies the period of time during which a current is caused to flow to LEDs of the LED circuit by, for example, a switching element such as an FET, etc. turning ON and OFF in response to input of a PWM signal, and controls lighting.

The PWM control circuit generates PWM signals, for example, in response to input of a lighting control signal, and makes the output timings of the generated PWM signals different from each other per drive circuit. In order to make the output timings of the PWM signals different per drive circuit, optional setting may be carried out by, for example, turning ON the LEDs per LED circuit one after another so that the period of time during which the LEDs are turned OFF is shortened as the entirety of the light source portion where the lighting control ratio is low.

Also, in the illumination device according to the invention, the PWM control circuit makes the output timings of the PWM signals different per drive circuit by the time obtained by dividing the lighting cycle by the number of LED circuits.

Thus, since the output timings of the PWM signals are made different from each other per drive circuit, that is, per LED circuit by the time obtained by dividing the lighting cycle by the number of LED circuits, the period of time during which the LEDs are turned off can be shortened as the entirety of the light source portion even if the lighting control ratio is lowered, wherein changes in the brightness are reduced, and the occurrence of flickering can be reduced.

Further, in the illumination device according to the invention, the PWM control circuit makes the output timings of the PWM signals different per drive circuit with the front side and the back side of the lighting cycle separate from each other.

Thus, since the output timings of the PWM signals different per drive circuit with the front side and the back side of the lighting cycle separate from each other, the period of time during which the LEDs are turned off can be shortened as the entirety of the light source portion even if the lighting control ratio is lowered, wherein changes in the brightness are reduced, and the occurrence of flickering can be reduced.

Also, in the illumination device according to the invention, the PWM control circuit makes the output timings of the PWM signals different per drive circuit in a range in which the lighting control ratio is lower than a predetermined lighting control ratio.

Thus, since the output timings of the PWM signals are made different per drive circuit, that is, per LED circuit in a range in which the lighting control ratio is lower than the predetermined lighting control ratio, occurrence of flickering can be reduced in a range having a low lighting control ratio, in which the brightness easily changes.

The range in which the lighting control ratio is lower than a predetermined lighting control ratio refers to, for example, a range where the brightness changes and flickering is brought about in a case where the output timings of the PWM signals are the same.

### BRIEF DESCRIPTION OF THE DRAWINGS

FIG. 1 is a circuit diagram of an illumination device according to Embodiment 1 of the invention;

FIG. 2 is a timing chart in which the output timings of PWM signals are made different from each other by PWM control of the same illumination device;

FIG. 3 is a timing chart showing a case were the output timings of the PWM signals are the same, as a comparative example of the PWM control of the same illumination device;

FIG. 4 is a configurational view of the same illumination device;

FIG. 5 is a front elevational view of a light source portion of the same illumination device; and

FIG. 6 is a timing chart in which the output timings of the PWM signals are made different from each other by PWM control of an illumination device according to Embodiment 2 of the invention.

### DETAILED DESCRIPTION OF THE PREFERRED EMBODIMENTS

Hereinafter, a description is given of embodiments of the invention with reference to the drawings.

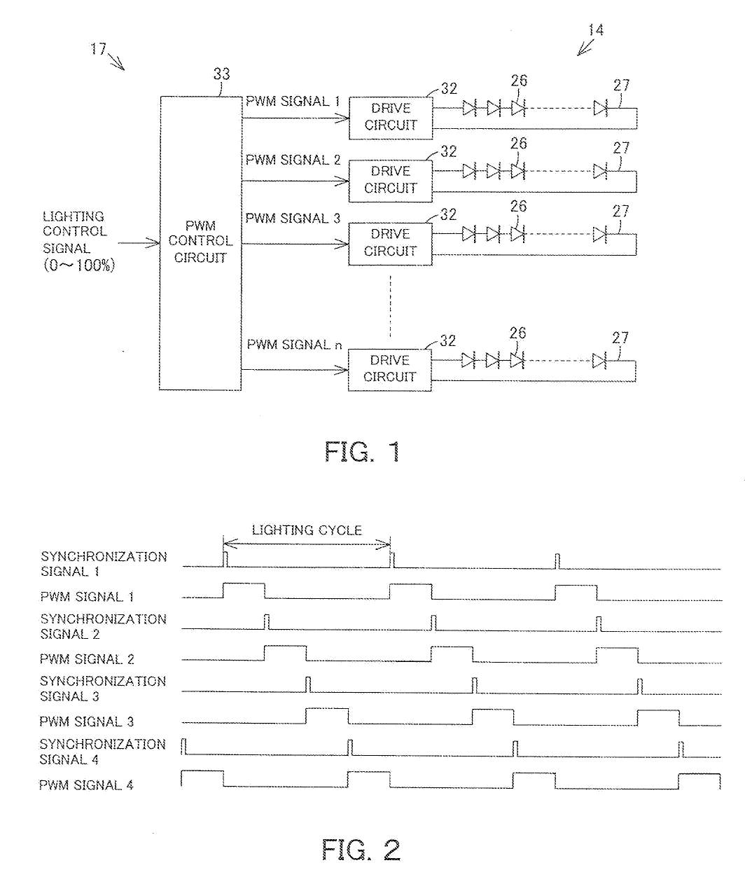

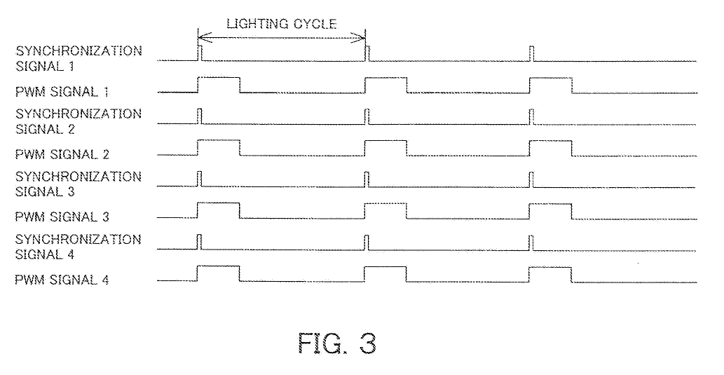

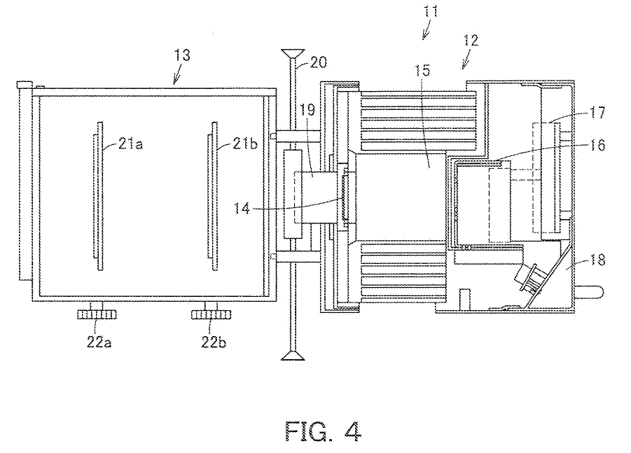

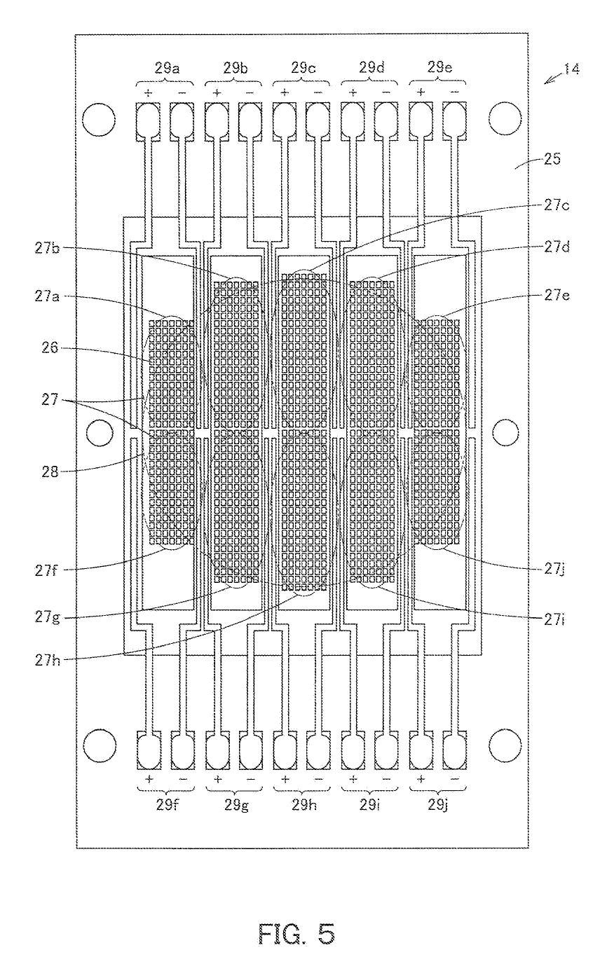

FIG. 1 through FIG. 5 show Embodiment 1. FIG. 1 is a circuit diagram of an illumination device, FIG. 2 is a timing chart in which the output timings of PWM signals are made different from each other by PWM control of the illumination device, FIG. 3 is a timing chart showing a case where the output timings of the PWM signals are the same, as a comparative example of the PWM control of the illumination device, FIG. 4 is a configurational view of the illumination device, and FIG. 5 is a front elevational view of a light source portion of the illumination device.

As shown in FIG. 4, an illumination device 11 is a spot light which is provided with a light source unit 12 for emitting light, and a projection unit 13 for projecting light emitted from the light source unit 12.

The light source portion 12 includes a light source portion 14 being a plane-shaped light, source, a radiator 15 for radiating heat generated by the light source portion 14, a power source portion 16 for supplying a lighting power source to the light source portion 14, a control portion 17 for controlling lighting of the light source portion 14, an operation portion 18 for operating lighting of the light source portion 14, a cylindrical light path 19 for guiding light of the light source portion 14 to a projection unit 13, and a cutter unit 20 for controlling the shape of light emitted from the cylindrical light path 19.

The projection unit 19 includes projection lenses 21a and 21b for condensing light emitted from the light source unit 12 and projecting the light outwards, and adjustment handles 22a and 22b for adjusting the projection distribution.

As shown in FIG. 5, the light source portion 14 is composed by mounting a plurality of chip-like LEDs 26 on a flat printed circuit board 25. LEDs 26 which emit white light are used in the light source portion 14. Also, LEDs 26 which emit red, green and blue lights as complementary colors may be used.

The light source portion 14 is composed so that a plurality of LED circuits 27 in which a plurality of LEDs 26 are connected in series and arrayed to be rectangular are grouped, and a light emitting area in which a plurality of LED circuits 27 are combined in plurality is approximated to a virtual circle 28.

FIG. 5 shows such an example in which the LED circuits 27 are grouped to ten LED circuits 27a through 27j. The respective LED circuits 27a through 27j individually have power source terminals 29a through 29j, and a lighting power source is supplied from the power source portion 16 to the power source terminals 29a through 29j in lighting control by the control portion 17, wherein LEDs 26 of the respective LED circuits 27a through 27j are lit. Thus, the respective LED circuits 27a through 27j are made electrically independent from each other.

Although the respective LED circuits 27a through 27j are formed by a plurality of LEDs 26 being arrayed to be rectangular, and are classified into three types in which a plurality of LEDs 26 are arrayed in rectangles having different sizes. In the respective LED circuits 27a through 27j, the short sides of the rectangles are the same for the three types, and seven LEDs 26 are connected in series at the short sides, wherein the series-connected circuits are connected in parallel by group. The LED circuits 27c and 27h at the middle part of the light source portion 14 belong to the group having the longest side in which the length of the long side of the rectangle is longest, the LED circuits 27a, 27e, 27f and 27j at both end parts belong to the group having the shortest side in which the length of the long side of the rectangle is shortest, and the LED circuits 27b, 27d, 27g and 27i at the intermediate part between the group having the longest side and the group having the shortest side belong to the intermediate group in which the length of the long side of the rectangle is an intermediate length.

As shown in FIG. 1, the control portion 17 is provided with a plurality of drive circuits 32 for driving the LEDs 26 per LED circuit 27 in response to input of the PWM signals and a PWM control circuit 33 for outputting PWM signals per drive circuit 32 in response to input of lighting control signals.

The respective drive circuits 32 turn ON and OFF switching elements such as FET in response to input of the PWM signals, and vary the period of time during which a current is caused to flow from the power source portion 16 to the LEDs 26 of the respective LED circuits 27 with the current value constant.

The PWM control circuit 33 generates PWM signals per drive circuit 32 in accordance with the lighting control ratio (level) 0 through 100% of the light control signal, simultaneously generates a synchronization signal at different timings per drive circuit 32 in lighting cycles of a predetermined lighting frequency, by which the LEDs 26 are lit, and outputs PWM signals at different output timings per drive circuit 32 in response to the synchronization signal. Although, for example, 256 gradations of lighting control signals are input in the PWM control circuit 33, the PWM control circuit 33 converts the gradations to a larger number of gradations such as 1024 gradations and 2048 gradations and outputs the PWM signals.

Here, FIG. 3 is a timing chart showing a comparative example in the case where the LED circuits 27 are composed of four systems and the output timings of the PWM signals per LED circuit 27 are the same. The comparative example shows a case where the LEDs 26 are lit at the lighting control ratio of 25%, and, at the same timing in the lighting cycle of the lighting frequency, by which the LEDs 26 are lit, in the four systems, synchronization signals are generated and PWM signals are output. Therefore, since the LEDs 26 are turned ON only at the front one-quarter of one lighting cycle and are turned OFF at the back three-quarters thereof, the brightness changes, and flickering is brought about. Where pictures are picked up by a television camera in such an illumination state, a phenomenon called flickering in which the brightness of the picked up pictures changes is brought about.

And, the timing chart of FIG. 2 shows a mode of the present embodiment in which the LED circuits 27 are composed of four systems and the output timings of the PWM signals per LED circuit 27 are made different from each other. In the mode of the embodiment, the output timings of the PWM signals are made different per drive circuit 32 by the time obtained by dividing one lighting cycle by the number of systems of the LED circuits 27.

In FIG. 2, since the LED circuits 27 are composed of four systems, the output timings of the PWM signals are made different from each other by one-quarter of one lighting cycle. The lighting frequency is, for example, 7.8 kHz or so.

Here, where the LED 26 is lit with the lighting control ratio of 25%, in one lighting cycle, the LED 26 of either one of the LED circuits 27 is lit among the four systems of LED circuits 27, and the LED 26 will always be lit as the entirety of the light source portion 14. Therefore, the brightness becomes constant. Also, in a range in which the lighting control ratio is 25% or more, lighting of the LED 26 of the four systems of the LED circuits 27 overlaps, wherein the LED 26 will always be lit as the entirety of the light source portion 14.

On the other hand, in a range in which the lighting control ratio is less than 25%, the time in which none of the LEDS 26 is lit is brought about when lighting of the LEDs 26 is changed over among the four systems of the LED circuits 27. However, since the period of time during which the LED 26 is turned off as the entirety of the light source portion 14 becomes remarkably less in comparison with the case where the output timings of the PWM signals are the same as shown in FIG. 3, the brightness changes less, and it is possible to reduce the occurrence of flickering. Further, since the time in which the LED 26 is turned off as the entirety of the light source portion 14 will be dispersed in one lighting cycle, a change in the brightness is small in comparison with a case where turning off is continued in series, wherein the occurrence of flickering can be reduced.

For this reason, where an object illuminated by the illumination device 11 is picked up by a television camera, it is possible to reduce the occurrence of a phenomenon called flickering, by which the brightness of the picked-up picture changes, particularly even if the lighting control ratio is lowered.

Thus, by adopting such a system in which the output timings of the PWM signals are made different from each other per drive circuit 32, occurrence of flickering can be reduced without increasing the lighting frequency of the LEDs 26 to lower flickering as in the prior arts. Therefore, since the lighting frequency of the LEDs 26 can be controlled to the extent of 3 through 4 kHz, no high performance is required with respect to the capacity of the CPU, which is used for the PWM control circuit 33, and the response efficiency of the drive circuit 32, wherein the component configuration can be made inexpensive.

Further, since the lighting cycle can be lengthened by lowering the lighting frequency of the LEDs 26, the number of gradations of the PWM signals can be made into a large number of gradations such as, for example, 1024 gradations and 2048 gradations, wherein the lighting of the LEDs 26 can be smoothly controlled.

Still further, since the lighting frequency of the LEDs 26 is controlled to be low, it is possible to reduce the occurrence of high frequency noise from the drive circuit 32 and the casing of the illumination device 11.

In addition, control to make the output timings of the PWM signals different from each other per drive circuit 32 may be carried out in a range in which the lighting control ratio is lower than a predetermined lighting control ratio at which the brightness changes to cause flickering to be brought about where the output timings of the PWM signals are the same. In a range in which the lighting control ratio is higher than a predetermined lighting control ratio, occurrence of a change in the brightness is less even if the output timings of the PWM signals are made same, wherein the output timings of the PWM signals may be made different or same per drive circuit 32.

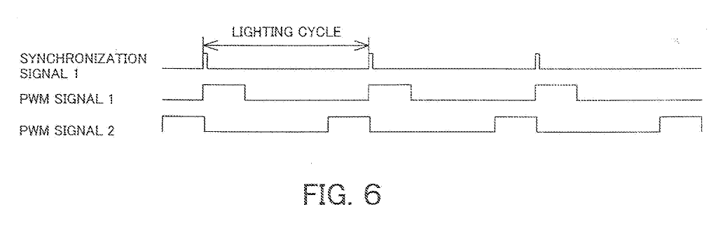

Also, FIG. 6 shows Embodiment 2, and the drawing is a timing chart in which the output timings of the PWM signals are made different by the PWM control of the illumination device.

The PWM control circuit 33 controls so as to make the output timings of the PWM signals different per drive circuit 32 with the front side and the back side of the lighting cycle separate from each other.

FIG. 6 shows a case where the LED circuits 27 are composed of two systems and the lighting control ratio is 25%, wherein a synchronization signal is generated with the front side and the back side of the lighting cycle separate from each other, and PWM signals are output at different output timings per drive circuit 32 in response to the synchronization signal. That is, the drive circuit 32 having an output timing of the PWM signal, that is, the LED circuit 27 is placed at the front side of the lighting cycle, and the drive circuit 32 having an output timing of the PWM signal, that is, the LED circuit 27 is placed at the back side of the lighting cycle. In this case, the output timing of the PWM signal output at the back side of the lighting cycle changes in response to the lighting control ratio.

In this case, both the PWM signals 1 and 2 are controlled by the same synchronization signal. After the synchronization signal, the PWM signal 2 is turned ON after the time (turning-off time) obtained by subtracting the time equivalent to the lighting time brought about by the PWM control from the lighting cycle elapses.

And, in a range in which the lighting control ratio is lower than 50%, the time in which every LED 26 is turned off is brought about when lighting of the LEDs 26 is changed over between the two systems of LED circuits 27. However, since the period of time during the LED 26 is turned off becomes remarkably small as the entirety of the light source portion 14 in comparison with the case where the output timings of the PWM signals are the same, for example, as shown in FIG. 3, changes in the brightness are less, and it is possible to reduce the occurrence of flickering.

What is claimed is:

1. An illumination device, comprising:
a light source portion including a plurality of LED circuits having LEDs;
a plurality of drive circuits for causing the LEDs to be lit per LED circuit in response to input of a PWM signal; and
a PWM control circuit for outputting the PWM signal per drive circuit in response to input of a lighting control signal and simultaneously making output timings of the PWM signal different from each other per drive circuit.

2. The illumination device according to claim 1, wherein the PWM control circuit makes the output timings of the PWM signals different per drive circuit by the time obtained by dividing the lighting cycle by the number of LED circuits.

3. The illumination device according to claim 1, wherein the PWM control circuit makes the output timings of the PWM signals different per drive circuit with the front side and the back side of the lighting cycle separate from each other.

4. The illumination device according to claim 1, wherein the PWM control circuit makes the output timings of the PWM signals different from each other in a range where the lighting control ratio is lower than a predetermined lighting control ratio.
